(19) United States
(12) Patent Application Publication
(10) Pub. No.: US 2011/0319520 A1
(43) Pub. Date: Dec. 29, 2011

(54) Polyolefin Drag Reducing Agents Produced by Multiple Non-Cryogenic Grinding Stages

(75) Inventors: Thomas Mathew, Friendswood, TX (US); Nagesh S. Kommareddi, Tulsa, OK (US); Jack Bradford Ward, Tulsa, OK (US)

(73) Assignee: Baker Hughes Incorporated, Houston, TX (US)

(21) Appl. No.: 13/182,603

(22) Filed: Jul. 14, 2011

Related U.S. Application Data
(63) Continuation-in-part of application No. 11/748,103, filed on May 14, 2007, now abandoned.

(51) Int. Cl. C08L 23/20; C08K 5/06; C08K 5/053; C08L 23/24

(52) U.S. Cl. 523/175

(57) ABSTRACT

Fine particulate polymer drag reducing agents (DRAs) in bi-modal or multi-modal particle size distributions may be produced simply and efficiently without cryogenic temperatures. The grinding or pulverizing of polymer, e.g. non-porous poly(alpha-olefin) suitable for reducing drag in hydrocarbons may be achieved by the use of at least one liquid grinding aid and at least two grinding processors in series. The blades of the stators of the grinders are of different configuration so that granulated polymer fed to the first processor having relatively larger gaps between blades is ground to an intermediate size which is fed to the second processor having relatively smaller gaps between blades which grinds the polymer to a second, smaller size. A non-limiting example of a suitable liquid grinding aid includes a blend of propylene glycol, water and hexanol. Particulate DRA may be produced at a size of 300 microns or less in only two passes.

### CROSS-REFERENCE TO RELATED APPLICATION

This application is a continuation-in-part patent application of U.S. Ser. No. 11/748,103, filed May 14, 2007, incorporated herein by reference in its entirety.

### TECHNICAL FIELD

The invention relates to processes for producing polymeric drag reducing agents in a finely divided particulate form, and most particularly to processes for grinding non-porous, polymeric drag reducing agents to produce fine particulates thereof in two or more passes that do not require grinding at cryogenic temperatures.

### BACKGROUND

The use of poly(alpha-olefins) or copolymers thereof to reduce the drag of a hydrocarbon flowing through a conduit, and hence the energy requirements for such fluid hydrocarbon transportation, is well known. These drag reducing agents or DRAs have taken various forms in the past, including slurries or dispersions of ground polymers to form free-flowing and pumpable mixtures in liquid media. A problem generally experienced with simply grinding the polyalpha-olefins (PAOs) is that the particles will “cold flow” or stick together after the passage of time, thus making it impossible to place the PAO in the hydrocarbon liquid where drag is to be reduced, in a form of suitable surface area, thus particle size, that will dissolve or otherwise mix with the hydrocarbon in an efficient manner. Further, the grinding process or mechanical work employed in size reduction tends to degrade the polymer, thereby reducing the drag reduction efficiency of the polymer.

One common solution to preventing cold flow during the grinding process is to coat the ground polymer particles with an anti-agglomerating agent (blocking agent). Cryogenic grinding of the polymers to produce the particles prior to or simultaneously with coating with an anti-agglomerating agent has also been used. However, such powdered or particulate DRA suffer from degradation of drag reduction performance due to molecular weight reduction during the mechanical comminution process. Also, such processes are expensive as they consume large quantities of liquid refrigerants such as liquid nitrogen, helium, argon and the like.

Gel or solution DRAs (those polymers essentially being in a viscous solution with hydrocarbon solvent) have also been tried in the past. However, these drag reducing gels also demand specialized injection equipment, as well as pressurized delivery systems. The gels or the solution DRAs are stable and have a defined set of conditions that have to be met by mechanical equipment to pump them, including, but not necessarily limited to viscosity, vapor pressure, undesirable degradation due to shear, etc. The gel or solution DRAs are also limited to about 10% activity of polymer as a maximum concentration in a carrier fluid due to the high solution viscosity of these DRAs. Thus, transportation costs of these DRAs are considerable, since up to about 90% of the volume being transported and handled is inert material.

From reviewing the many prior patents in this field it can be appreciated that considerable resources have been spent on both chemical and physical techniques for easily and effectively delivering drag reducing agents to the fluid that will have its friction reduced. Yet none of these prior methods has proven entirely satisfactory. For instance, in conventional non-cryogenic grinding processes multiple passes through the grinder, on the order of 30 passes or runs, are necessary to reduce the particle size sufficiently. This many passes are very time- and energy-intensive. Thus, there needs to be a more efficient process of size reduction.

Thus, it would be desirable if a drag reducing agent could be developed which rapidly dissolves in the flowing hydrocarbon (or other fluid), which could minimize or eliminate the need for special equipment for preparation and incorporation into the hydrocarbon at the site of the flowing fluid, and which could be formulated to contain greater than 10% polymer to reduce storage and transportation of inert material. It would also be desirable to have a process for producing particulate drag reducing agent that did not require cryogenic grinding in its preparation and/or only grinding under ambient temperature conditions in as few passes or runs as possible.

### SUMMARY

There is provided, in one form, a method for producing a particulate polymer drag reducing agent dispersion in liquid that involves feeding to a first processor components that include granulated non-porous polyolefin and at least one liquid grinding aid. The components are ground to produce intermediate particulate non-porous polyolefin drag reducing agent of a first size, which in turn is fed to a second processor. These intermediate particulate non-porous polyolefin drag reducing agent of a first size are then ground to produce particulate non-porous polyolefin drag reducing agent of a second size smaller than the first size, where the liquid in the dispersion is the liquid grinding aid. This process can be repeated through multiple processors to continually and further reduce the size of the particulate non-porous polyolefin. This method is highly efficient in reducing the particle size of the polymer compared to previous wet granulation methods, and also provides a simple way of producing bi-modal and multi-modal particle size distributions.

Optionally, the processors each have rotors and stators, where the stator blades of the first processor are relatively more open than the stator blades of the second processor. In another non-limiting embodiment the grinding is conducted in the absence of cryogenic temperatures.

In another alternate embodiment, the intermediate (first) size of the particulate non-porous polyolefin drag reducing agent is between about 550 to about 450 microns, where the second size is from about 200 to about 300 microns. The choice of impeller and grinding head combinations for further processing can be adjusted to reach the desired size for the particulate polyolefin.

### BRIEF DESCRIPTION OF THE DRAWINGS

FIG. 1 is a schematic diagram of a general method for the manufacture of an organic solvent-based carrier drag reducing agent product; and

FIG. 2 is a schematic diagram of a general method for the manufacture of a water-based carrier drag reducing agent product.

It will be appreciated that the diagrams of the Figures are schematic illustrations and are not to scale or proportion.

### DETAILED DESCRIPTION

Prior processes for reducing the size of polymer drag reducing agents (DRAs) have involved multiple passes or runs through a grinder, recycling the material up to as much as 30 times to achieve sufficient size reduction. This is inefficient. Secondly, it is desirable to have an efficient and simple way of producing bi-modal and multi-modal particle size distributions. Bi-modal and multi-modal particle size distributions can be very important to DRA product performance in pipelines. A bimodal particle size distribution is one that includes two different particle size distributions that have peaks at different sizes, whereas multi-modal refers to a combination of more than two different particle size distributions. Bi-modal or multi-modal particle size distributions that have the desired distributions have generally not been made simply or efficiently, before now.

A process has been discovered by which only two grinders or processors, or more than two grinders or processors, in series may be utilized in combination with a liquid grinding aid to render a granulated polyolefin polymer into a ground state of fine particles of about 300 microns or less at non-cryogenic conditions in only two passes, in one non-limiting embodiment (one pass in each grinder or processor). The process in one non-limiting embodiment involves the introduction of applied liquid grinding aid (composed of wetting properties such that lubricity is imparted to the grinding system) optionally in unison with the introduction of a solid organic dispersion aid into the grinding chamber such that particle agglomeration of soft polyolefins is minimized or prevented. The solid dispersion aid may also be used to improve the suspension action helpful in the grinding or pulverizing chamber to achieve the small polymer particles of about 600 microns or less (intermediate stage) or 300 microns or less (second stage) to give representative, non-limiting size thresholds. Use of a single or combination liquid grinding aid such as the wetting agent, and passing the polymer through two processors or grinders in series with different stator blade configurations produces particle sizes on the order of about 200-300 microns.

In one non-limiting embodiment, the grinding for producing particulate polymer drag reducing agent is conducted at non-cryogenic temperatures. For the purposes herein, cryogenic temperature is defined as the glass transition temperature (T_{g}) of the particular polymer having its size reduced or being ground, or below that temperature. It will be appreciated that T_{g} will vary with the specific polymer being ground. Typically, T_{g} for the non-porous poly(alpha-olefins) ranges between about −10° C. and about −100° C. (about 14° F. and about −148° F.), in one non-limiting embodiment. In another non-restrictive version, the grinding for producing particulate polymer drag reducing agent is conducted at ambient temperature. For the purposes herein, ambient temperature conditions are defined as between about 4 to about 40° C. (about 39 to about 104° F.). In an alternate non-limiting embodiment, ambient temperature is defined as the temperature at which grinding occurs without any added cooling. Because heat is generated in the grinding process, “ambient temperature” may thus in some contexts mean a temperature greater than about 4 to about 40° C. (39 to about 104° F.). In still another non-limiting version herein, the grinding to produce particulate polymer drag reducing agent is conducted at a chilled temperature that is less than ambient temperature, but that is greater than cryogenic temperature for the specific polymer being ground. One suitable chilled temperature may range from about −7 to about 2° C. (about 20 to about 35° F.).

The liquid grinding aid may be added in relatively large quantities. One purpose of the liquid grinding aid is to aid in the lubricity of the pulverizing system such that hot spots due to mechanical shear are greatly reduced or eliminated. As noted, some rise in temperature is expected with any grinding. Also, without the addition of the liquid grinding aid in sufficient quantities, rubbery polymer tends to build up on the cutting blade surfaces. That is, gumming up and failure of the grinder may occur. Again, lubricity of the system plays an important role in maintaining an efficient grinding operation; an efficient system as defined by a smooth flowing pulverizing operation with little polymer build-up on metal surfaces, lack of agglomerated polymer formation, and in conjunction with suitable production rates. Suitable production rates include, but are not necessarily limited to, a minimum of about 2 to an upper rate of about 9 gallons per minute (about 7.6 to about 23 liters/min.). Alternatively, a suitable production rate may range from about 5 independently to about 7 gallons per minute.

Generally, the polymer that is processed in the methods herein may be any conventional or well known polymeric drag reducing agent (DRA) including, but not necessarily limited to, poly(alpha-olefin), vinyl acetate polymers and copolymers, poly(alkylene oxide), polyacrylates and mixtures thereof and the like. For the methods to be successful, the polymeric DRA would have to be of sufficient structure (molecular weight) to exist as a neat solid which would lend itself to the pulverizing process, i.e. that of being sheared by mechanical forces to smaller particles. A DRA of a harder, solid nature (relatively higher glass transition temperature) than poly(alpha-olefin) would certainly work.

Alpha-olefins that may be polymerized to give poly(alpha-olefins) useful as drag reducing agents include, but are not necessarily limited to, 1-hexene, 1-octene, 1-decene, 1-dodecene, 1-tetra-decene and mixtures thereof. Ethylene and the lower alpha-olefins such as propylene and 1-butylene (butene) are specifically excluded, that is, they are absent. Alternatively the poly(alpha-olefins) used in the methods herein explicitly exclude polypropylene and polyethylene.

The polymers used in the present methods are non-porous and porosity is 0% or essentially 0%. The polymers, especially poly(alpha-olefins), do not include or contain interconnected porous networks. This is in contrast to the polymers described in the process of U.S. Patent Application Publication No. 2001/0002384 which requires that the organic polymers be porous, typically having at least about 40% porosity, more typically at least about 60% porosity, that is, the volume of the pores represent such percentages of the total volume of the particles typically from the standpoint of the average percent porosity of the particles. Instead, the polymers herein are solid, rubbery particles. Additionally, it is not apparent that methods used to grind porous polymers are applicable to grinding of non-porous polymers that are solid, rubbery particles.

Some further details about continuously polymerizing DRA polymers may be found in U.S. Pat. Nos. 6,649,670 and 7,119,132, both incorporated by reference herein in their entirety. Patent documents involving granulation using liquid grinding aids include U.S. Pat. Nos. 6,894,088, 6,946,500 and 7,271,205, all incorporated by reference herein in their entirety. However, not all teachings of these patent documents are applicable to the method described herein. For instance, the process of U.S. Pat. No. 6,946,500 involves the addition of separate streams of liquid and solid into a grinding chamber. In the present method, the composition of the required recipe is fed in the form of a dispersion of solids in a liquid or combination of liquids to both grinding stages. There is a single stream going in and a single stream coming out. The proportionality of the liquid stream to the solid stream is not varied as in U.S. Pat. No. 6,946,500.

Poly(alpha-olefin) is a suitable polymer in one non-limiting embodiment herein. Non-porous poly(alpha-olefins) (PAOs) are useful to reduce drag and friction losses in flowing hydrocarbon pipelines and conduits. Prior to the innovative processes and methods described herein, the polymer has already been granulated, such as by any of the previously noted techniques or other processes, that is, broken up or otherwise fragmented into granules of about 0.5 inch (1.3 cm) or less, alternatively in the range of about 6 mm independently to about 20 mm, or in another non-limiting embodiment from a lower threshold of about 8 mm independently up to about 12 mm. When used in conjunction with a parameter range herein, the term “independently” means that any lower threshold may be combined with any upper threshold for the range to form a suitable alternative range.

It is permissible for the granulated polymer to have an anti-agglomeration agent or dispersion aid thereon. Such anti-agglomeration agents or dispersion aids include, but are not necessarily limited to talc, alumina, magnesium stearate, ethylene bis-stearamide, UNITHOX™ 420 and 520 ethoxylate non-ionic emulsifier available from Baker Hughes Incorporated, calcium stearate, stearamide, and the like and mixtures thereof, and others known in the art. These dispersion aids will be described more completely below.

Within the context of methods and processes herein, the term “granulate” refers to any size reduction process that produces a product that is relatively larger than that produced by grinding. Further within the context of these methods, “grinding” refers to a size reduction process that gives a product relatively smaller than that produced by “granulation”. “Grinding” may refer to any milling, pulverization, attrition, cutting, homogenization, or other size reduction that results in particulate polymer drag reducing agents of the size and type that are the goal herein.

The solid organic grinding aid may be any finely divided particulate or powder that inhibits, discourages or prevents polymer particle agglomeration and/or polymer granule to granule fusing or cold flow during grinding. The solid organic grinding aid may also function to provide the suspending action necessary in the pulverizing or grinding step to achieve polymer particles of the desired size. The solid organic grinding aid itself has a particle size, which in one non-limiting embodiment ranges from about 1 to about 300 microns, alternatively from about 10 to about 50 microns. Suitable solid organic grinding aids include, but are not necessarily limited to, stearamide, ethene/butene copolymer (such as MICRO-THENE, available from Equistar, Houston), paraffin waxes (such as those produced by Baker Petrolite), solid, high molecular weight alcohols (such as UNILIN alcohols available from Baker Petrolite), and any non-metallic, solid compounds composed of C and H, and optionally N and/or O which can be prepared in particle sizes of 10-50 microns suitable for this process, and mixtures thereof. Ethylene bis- stearamide is effective as a solid, organic grinding aid also.

The liquid grinding aid provides lubricity to the system during grinding. Suitable liquid grinding aids include any which impart lubricity to the surface of the polymer being ground. Specific examples include, but are not necessarily limited to, a blend of a glycol with water and/or an alcohol. Suitable glycols include, but are not necessarily limited to, ethylene glycol, propylene glycol, diethylene glycol, dipropylene glycol, methyl ethers of such glycols (including, but not necessarily limited to, dipropylene glycol monomethyl ether, polypropylene glycol methyl ether, ethylene glycol methyl ether, etc.) and the like, and mixtures thereof. Suitable alcoholic liquids include, but are not necessarily limited to, methanol, ethanol, butanol, isopropanol (isopropyl alcohol, IPA), hexanol, heptanol, octanol and the like and mixtures thereof. Liquid grinding aids that are non-harmful to the environment are particularly desirable. In one non-limiting embodiment herein, the liquid grinding aid is the blend of propylene glycol, water and hexanol. The proportions of the three components in this blend may range from about 2 independently to 80 wt. % glycol to about 20 independently to 98 wt. % water to about 0 independently to 30 wt. % alcohol, alternatively from about 20 independently to 80 wt. % to about 20 independently to 80 wt. % to about 0 independently to 20 wt. %. That is, in some embodiments, the alcohol is optional. In certain other alternative versions, it may be possible that no glycol is necessary and the liquid grinding aid is essentially water. In non-restrictive versions, when a glycol and an alcohol are used, the slurry may be considered organic solvent-based; when a glycol and water are used, the slurry may be considered water-based. In one non-limiting embodiment herein, the liquid grinding aid is introduced into the grinding or pulverizing chamber before, after, or along with the polymer granules as they are fed to the chamber and simultaneously or subsequently stirred or mixed. It need not be atomized or sprayed into the grinding or pulverizing chamber.

It will be appreciated that there will be a number of different specific ways in which the methods may be practiced, but that are not specifically described herein. For instance, in one non-limiting embodiment herein, the granulated polymer is fed into the grinding chamber of the processors at a rate of from about 210 to about 660 lbs/hr (about 95 to about 300 kg/hr), the optional solid organic dispersion aid is fed at a rate of from about 60 to about 180 lb/hr, and the liquid grinding aid is fed at a rate of from about 600 to about 1680 lbs/hr (about 272 to about 762 kg/hr). As noted, all of the components may be fed simultaneously to the grinding chamber. Alternatively, the components may be mixed together prior to being fed to the grinding chamber. In an alternate version herein, the components are added sequentially, in no particular order or sequence. In one non-restrictive version, the liquid grinding aid and optional dispersion aid are added only to the first processor, but in another non-limiting embodiment may be added to any of the sequential processors. The purpose of the dispersion aid (generally a solid particulate) is not to dry the polymer or to absorb the liquid. The dispersion aid serves as a stabilizing and dispersing agent. The dispersion aid helps the polymer particles stay dispersed in the liquid and prevents or inhibits agglomeration of the polymer particles. Suitable dispersion aids include those previously discussed, for instance, ethylene bis-stearamide, in one non-limiting embodiment.

In another non-restrictive embodiment herein, the method uses an advanced rotor/stator combination in two or more stages or passes in series. This is a very efficient reduction process for producing polymer particles compared to existing conventional grinding processes, particularly those that recycle the polymer particulates ten, twenty or thirty times to achieve the desired size. Suitable rotor/stator equipment for the methods herein include, but are not limited to, COMITROL® processors available from URSCHEL® Laboratories. The stator has multiple removable blades on the periphery of a microcut head. An impeller on a rotor forces the polymer granules into the cutting stator blades. These blades may be removed and reversed, thereby extending the life of the stator. The rotor may have a uni-cut or veri-cut impeller based on the particle size of the feed to the grinder or processor. Veri-cut impeller blades are more open and are used for coarse cutting; that is, to produce a larger, coarser particle. Uni-cut impeller blades are more closed and are used for finer grinding. In the methods herein, a first processor having a veri-cut impeller would grind the granulated polymer to an intermediate polymer particle of a first or intermediate size, which would be fed to a second processor in series with the first processor, where the second processor had a uni-cut impeller to grind the intermediate polymer to a final or second size smaller than the first size. Generally, the first impeller is relatively more open than the second impeller. In one non-limiting embodiment, the impeller of the first processor is semi-open and the impeller of the second processor is closed. Open, semi-open and closed impellers are well known in the art. In a non-restrictive alternative, the first processor and second processor each have blades, where the blades of the second processor are configured differently than the blades of the first processor, while seated on the cutting head. This change in configuration will result in a smaller gap between the blades for the polymer to be forced through during the pulverizing process. Similarly, subsequent processors, if employed, would have incrementally different and smaller gaps between the blades to achieve a still more reduced size. For instance, the gaps between the blades on a subsequent processor would be smaller and/or more closed blades relative to the immediate previous processor.

The blades on the microcut head of these processors may be arranged or oriented at an angle to provide maximum cutting efficiency. In another non-limiting embodiment, the grinding edges may be coated with tungsten carbide to eliminate, reduce or mitigate wear. With properly selected grinding heads, the polymer particle size may be reduced to the 200-300 micron range in two passes (one pass each per processor in series). In earlier grinding technology for PAO applications, multiple passes were required (e.g. approximately 30 passes or runs) to get the same particle size reduction. Furthermore, such prior methods of repeated recycling of the particulate polymer back through the same machine ultimately produced particles of only one particle size distribution. On these conventional machines, the polymer particles were recycled through the same machine until the desired particle size was achieved.

In the methods herein, two different processors or grinders with different cutting blades are used in series and the material is not normally recycled to achieve the smaller sizes. In an alternate, non-limiting embodiment, optional recycling of some of the particles may be performed to achieve a final polymer particle product that has a desired bi-modal or multi-modal size distribution. Bi-modal and/or multi-modal size distributions are important in the dissolution of DRA polymers in a flowing hydrocarbon in a pipeline because the smaller particles will dissolve and become effective first and the larger particles will last until further down the pipeline flow to continue to provide drag reduction to the hydrocarbon stream. More information about bi-modal or multi-modal size distributions for DRAs may be found in U.S. Pat. No. 7,939,584, incorporated herein by reference in its entirety. A bi-modal particle size distribution may also be achieved by not feeding all of the intermediate particulate polyolefin from the first processor to the second processor for further grinding. The diverted intermediate particulate polyolefin DRA would then be combined with at least part of the final particulate polyolefin DRA of reduced size from the second processor to form the final DRA product. This novel concept can be extended out to multi-modal particle size distributions of polyolefin DRA, utilizing multiple processors.

In another non-limiting embodiment, two or more grinders or processors may be stacked on top of one another, that is, vertically one over the other. This orientation or configuration will reduce the overall footprint and enable processing sequential and/or multiple passes through the same machine, for instance recycling the particles back to one or both of the processors or grinders.

One non-restrictive embodiment will have the size of the intermediate particulate polymer from the first processor be between about 550 to about 450 microns, alternatively the lower end of this range may independently be about 475 microns and the upper end of this range may independently be about 525 microns. In one non-limiting embodiment, it is expected that the processes described herein will produce particulate polymer drag reducing agent product where the average particle size ranges from about 175 microns independently to about 325 microns, in another non-restrictive embodiment from about 200 independently to about 300 microns, alternatively where at least 90 wt % of the particles have a size of less than about 300 microns or less, in another alternate version 100 wt. percent of the particles have a size of 250 microns or less. Alternatively, the resultant particulate non-porous poly(alpha-olefin) drag reducing agent may have a final average particle size (sometimes called a second size herein) that is less than 500 microns, alternatively less than 300 microns, more typically less than 250 microns and still more typically less than 200 microns.

It is expected that the resulting particulate polymer DRAs may be easily transported in the form of a particulate dispersion in liquid as contrasted with a powdery product. The liquid in the dispersion may be the liquid grinding aid, together with additional materials added after the finished product is formed (e.g. any of the previously mentioned liquids suitable as the liquid grinding aid or other compatible liquids that are non-solvents for the polymer DRA). The particulate polymer DRAs may be readily inserted into and incorporated within a flowing hydrocarbon, aqueous fluid, oil-in-water emulsion or water-in-oil emulsion, as appropriate. DRA products made by the processes and methods herein are free-flowing and contain a high percentage, up to about 50% of active polymer, alternatively from about 10-40% of active polymer.

Unlike the process for reducing the particle size of porous organic polymers, such as polyethylene and polypropylene, described in U.S. Patent Application Publication No. 2001/0002384, the particulate poly(alpha-olefins) used as drag reducers herein are essentially non-porous and water or other liquid, such as a liquid grinding aid, cannot be present inside the particulate poly(alpha-olefins). All of the liquid is external to the particles, and the liquid grinding aid occupies 0% of the internal volume of the particles. This is in contrast to the particles of U.S. Patent Application Publication No. 2001/0002384 where typically water will occupy at least about 10%, more preferably at least about 50% of the pore volume of the particles or even great than about 85% of the volume of the pores within said particles.

In U.S. Patent Application Publication No. 2001/0002384, the density of the porous polymers can be significantly less than water, such as less than 0.5 g/cc. In contrast, the particle density of the non-porous poly(alpha-olefins) here is at least about 0.82 g/cc, significantly higher than the 0.5 g/cc of the porous polymers mentioned previously. The density of the poly(alpha-olefin) particles does not increase when exposed to liquid. Thus, the particle density of the poly(alpha-olefin) drag reducing particles described herein is essentially constant, as contrasted with the particle density of the particles of 2001/0002384 which is variable based on how much water has soaked in.

Further, the process in the present method is conducted at atmospheric pressure and is never subjected to a pressure of less than one atmosphere (vacuum) as in U.S. Patent Application Publication No. 2001/0002384.

The method described herein may also be practiced in the absence of a particle recovery step. That is, there is no need for filtration (e.g. rotary and vacuum filters), screens (such as vibrating screens) and/or centrifuges. Furthermore, no dewatering is necessary. The solid/liquid combination is ground in a processor and what comes out directly is the finished product. There is no need to remove the liquid to concentrate or dry the polymer to a free-flowing powder. The final drag reducing agent dispersion in liquid is a liquid slurry, not a powder. Unusually, as will be demonstrated, the liquid of the product dispersion (slurry) may be either organic solvent-based or water-based.

Furthermore, there is no possibility of further reaction on the surface of the particles to give complex functionality. The poly(alpha-olefin) particles are organic, hydrophobic and fully saturated, and they cannot be made hydrophilic to any degree. This is in contrast to U.S. Patent Application Publication No. 2001/0002384 which discloses that the external and internal surfaces of the particles (since they are porous) can also be modified during manufacture to produce a hydrophilic character or a combination of hydrophilic character and hydrophobic character. Since the poly(alpha-olefins) produced in one non-limiting embodiment of the present method are to serve as drag reducing agents in hydrocarbons, they should be oleophilic or dissolvable in a flowing hydrocarbon to impart friction reduction or drag reduction thereto.

The invention will now be further described with respect to specific examples that are provided only to further illustrate the invention and not limit it in any way.

### EXAMPLES 1-4

Grinding of polyolefin polymer for DRA particles was conducted in a two-pass process, one pass sequentially each through two processors or grinders where the impeller of the first processor was semi-open and the impeller of the second processor was closed. The following data were developed.

### Example #1

Particle size (mv) 259 microns

Particle size (D95) 493 microns

### Example #2

Particle size (mv): 197 microns

Particle size (D95): 360 microns

### Example #3

Particle size (mv): 268 microns

Particle size (D95): 497 microns

### Example #4

Particle size (mv): 249 microns

Particle size (D95): 425 microns

“mv” refers to the mean diameter of the volume distribution and represents the center of gravity of the particle size distribution curve. The particle size given first is the final particle size after the second pass, where “D95” refers to about 95% of the particles being at or below this size. The initial particle size is 8 mm-12.7 mm on the polymer granules. It may be seen that polyolefin DRA particles of 300 microns or less may be achieved in the two-pass method herein.

### Example 5

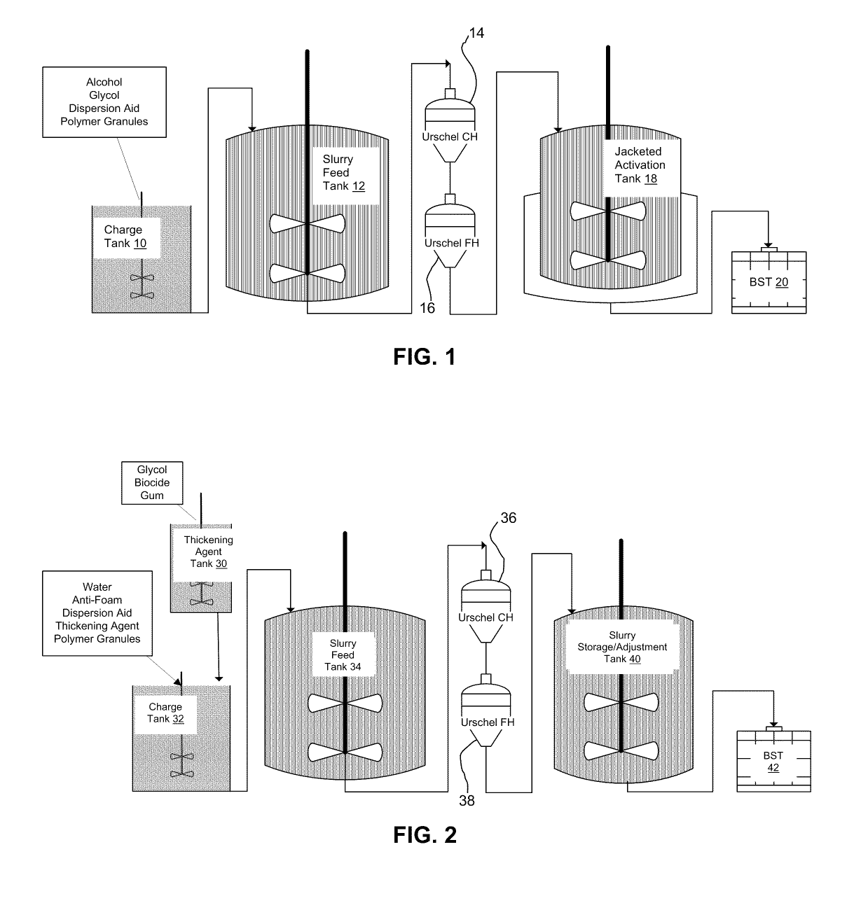

A general method for the manufacture of an organic solvent-based carrier drag reducing agent is described with respect to FIG. 1. The components, are given in Table I.

TABLE I

| Proportion - Wt. % | Component |
|---|---|
| 45-55 | Alcohol (e.g. 1-hexanol) |
| 15-20 | Glycol (e.g. mixture of dipropylene glycol |
| | monomethyl ether/polypropylene glycol methyl |
| | Ether) |
| 3-8 | Dispersion aid (e.g. ethylene bis-stearamide) |
| 15-32 | Polymer granules (e.g. FLO ™ 1020 Bulk DRA, |
| | from Baker Hughes) |

The general procedure is as follows:

1. Into Charge Tank 10, charge alcohol and glycol.

2. Into Charge Tank 10 and with agitation, charge dispersion aid. Disperse fully.

3. Into Charge Tank 10 with agitation charge polymer granules.

4. Transfer slurry from Charge Tank 10 to the Slurry Feed Tank 12.

5. Line up transfer lines from the Slurry Feed Tank 12 to the Jacketed Activation Tank 18 via polymer grinding units (i.e. cascaded URSCHEL® processors CH (coarse head) 14 and FH (fine head) 16)

6. At a feed rate of 4 to 8 gallons per minute, feed polymer slurry from Slurry Feed Tank 12 though the polymer grinding units CH 14 and FH 16 to the Jacketed Activation Tank 18.

7. In the agitated Jacketed Activation Tank 18 heat ground slurry to 135° F. to 145° F.

8. With agitation, cool slurry to 70° F. to 90° F. (Slurry can also be cooled through an exchanger as it is being discharged.)

9. Discharge product to storage tank or Bulk Storage Tank/Intermediate Bulk Container (BST/IBC) 20.

### Example 6

A general method for the manufacture of a water-based carrier drag reducing agent is described with respect to FIG. 2. The components are given in Table II.

TABLE II

| Proportion - Wt % | Component |
|---|---|
| 65-80 | Water |
| 0.50 | Anti-foam (e.g. Dow Corning 2-3101 emulsion) |
| 3-5 | Dispersion aid (e.g. UNITHOX 420 ethoxylate |
| | non-ionic emulsifier) |
| 0.25 | Biocide (e.g. Dow ROCIMA BT 2S liquid |
| | biocide) |
| 2-3 | Glycol (e.g. dipropylene glycol) |
| 0.15 | Thickening/viscosity modifying agent (e.g. diutan |
| | gum) |
| 20-30 | Polymer granules (e.g. FLO ™ 1020 Bulk DRA, |
| | from Baker Hughes) |

The general procedure is as follows:

1. Into Charge Tank 32, charge water.

2. Into Charge Tank 32 with agitation, charge Anti-foam and Blocking Agent. Mix until fully dispersed.

3. Into Thickening Agent Tank 30, charge glycol and biocide.

4. Into Thickening Agent Tank 30 with agitation, charge Thickening/Viscosity Modifying Agent. Disperse fully.

5. Transfer contents of Thickening Agent Tank 30 into Charge Tank 32. Allow thickening agent to full activate to achieve maximum viscosity.

6. Into Charge Tank 32 with agitation, charge polymer granules.

7. Transfer slurry from Charge Tank 32 to the Slurry Feed Tank 34.

8. Line up transfer lines from the Slurry Feed Tank 34 to the Slurry Storage/Adjustment Tank 40 via polymer grinding units (i.e. cascaded URSCHEL® processors CH 36 and FH 38)

9. At a feed rate of 4 to 8 gallons per minute, feed polymer slurry from Slurry Feed Tank 34 though the polymer grinding units CH 36 and FH 38 to the Slurry Storage/Adjustment Tank 40.

10. Transfer adjusted slurry to final storage tank or BST/IBC 42.

An efficient process for producing a bi-modal or multi-modal, particulate polymer drag reducing agent of suitable small particle size and adequate surface area in two passes, one each sequentially through different grinders or processors, which will readily dissolve and dissipate in flowing hydrocarbon streams has been provided. These non-porous particulate polymer DRAs may be simply and readily manufactured and do not require cryogenic temperatures to be produced. These bi-modal or multi-modal polymer particulates do not require multiple recycling of the particles to the same machine, e.g. on the order of 10, 20 or 30 recycle passes. These particulate polymer DRAs do not cold flow upon standing once they are made. The polymer DRAs here may be made without the need to subject any part of the process to vacuum. Instead, the granulated polymers, such as granulated non-porous poly(alpha-olefins) and liquid grinding aid may be brought together at atmospheric pressure and not under vacuum, which vacuum is preferred in U.S. Patent Application Publication No. 2001/0002384.

Many modifications may be made in the composition and process of this invention without departing from the spirit and scope thereof that are defined only in the appended claims. For example, the exact nature of and proportions of polymer, processors or grinders, optional solid organic dispersion aid, and liquid grinding aid may be different from those used here. Particular processing techniques may be developed to enable the components to be homogeneously blended and work together well, yet still be within the scope of the invention. Additionally, feed rates of the various components are expected to be optimized for each type of grinding equipment and for each combination of components (e.g. polymer and liquid grinding aid) employed.

The words “comprising” and “comprises” as used throughout the claims is interpreted “including but not limited to”.

The present invention may suitably comprise, consist or consist essentially of the elements disclosed and may be practiced in the absence of an element not disclosed. For instance, a method for producing a particulate poly(alpha-olefin) drag reducing agent dispersion in liquid may consist essentially of or alternatively consist of (1) feeding to a first processor components comprising, consisting essentially of or consisting of granulated non-porous poly(alpha-olefin) and at least one liquid grinding aid, (2) grinding the components to produce intermediate parti- culate non-porous poly(alpha-olefin) drag reducing agent of a first size, (3) feeding to a second processor the intermediate particulate non-porous poly(alpha-olefin) drag reducing agent of a first size, and (4) grinding the components to produce the particulate non-porous poly(alpha-olefin) drag reducing agent dispersion in liquid of a second size smaller than the first size, where the liquid in the dispersion is the liquid grinding aid.

What is claimed is:

1. A method for producing a particulate poly(alpha-olefin) drag reducing agent dispersion in liquid, comprising:
feeding to a first processor components comprising:
granulated non-porous poly(alpha-olefin); and
at least one liquid grinding aid;
grinding the components to produce intermediate particulate non-porous poly(alpha-olefin) drag reducing agent of a first size;
feeding to a second processor the intermediate particulate non-porous poly(alpha-olefin) drag reducing agent of a first size; and
grinding the components to produce the particulate non-porous poly(alpha-olefin) drag reducing agent dispersion in liquid of a second size, wherein the second size is smaller than the first size and the liquid in the dispersion is the liquid grinding aid.

2. The method of claim 1 where the first processor and the second processor have impellers, and the impeller of the first processor is more open than the impeller of the second processor.

3. The method of claim 1 where the grinding by both processors is conducted in the absence of cryogenic temperatures.

4. The method of claim 1 where the granulated non-porous poly(alpha-olefin) and the at least one liquid grinding aid are fed as a single dispersion to the first processor.

5. The method of claim 1 where particulate non-porous poly(alpha-olefin) drag reducing agent dispersion in liquid is not recycled to either processor.

6. The method of claim 1 where in the feeding, the granulated non-porous poly(alpha-olefin) has an average diameter of 0.5 inch (1.3 cm) or less.

7. The method of claim 1 where the first size of the intermediate particulate non-porous poly(alpha-olefin) drag reducing agent is an average particle size of from about 550 to about 450 microns.

8. The method of claim 1 where the second size of the particulate non-porous poly(alpha-olefin) drag reducing agent is an average particle size of from about 175 to about 325 microns.

9. The method of claim 1 where the liquid grinding aid is a blend of at least one glycol selected from the group consisting of ethylene glycol, propylene glycol, diethylene glycol, dipropylene glycol, methyl ethers of such glycols, and mixtures thereof, and at least one alcohol, the alcohol being selected from the group consisting of methanol, ethanol, butanol, isopropanol, hexanol, heptanol, octanol and mixtures thereof.

10. The method of claim 1 where the liquid grinding aid is a blend of at least one glycol selected from the group consisting of ethylene glycol, propylene glycol, diethylene glycol, dipropylene glycol, methyl ethers of such glycols, and mixtures thereof, and water where the proportions range from about 2 to 80 wt. % glycol to about 20 to 98 wt. % water.

11. The method of claim 1 where the granulated non-porous poly(alpha-olefin) is fed at a rate of from about 210 to about 660 lbs/hr (about 95 to about 300 kg/hr) and the liquid grinding aid is fed at a rate of from about 600 to about 1680 lbs/hr (about 272 to about 762 kg/hr).

12. The method of claim 1 where at least some of the intermediate particulate non-porous poly(alpha-olefin) drag reducing agent of a first size from the first processor is diverted rather than fed to the second processor, and at least part of the diverted intermediate particulate polyolefin drag reducing agent of a first size is combined with at least part of the particulate poly(alpha-olefin) drag reducing agent of a second size to give a bi-modal or multi-modal drag dispersion in liquid reducing agent product.

13. The method of claim 1 further comprising feeding the particulate non-porous poly(alpha-olefin) drag reducing agent to at least one subsequent processor and grinding the particulate non-porous poly(alpha-olefin) drag reducing agent to a third size smaller than the second size.

14. The method of claim 1 further consisting essentially of only the two feeding and two grinding operations in the absence of any subsequent grinding operations.

15. The method of claim 1 further comprising feeding a solid organic dispersion aid to the first processor.

16. A method for producing a particulate non-porous poly(alpha-olefin) drag reducing agent dispersion in liquid, comprising:
feeding to a first processor with a stator having blades, components comprising:
granulated non-porous poly(alpha-olefin) polymerized from an alpha-olefin selected from the group consisting of 1-hexene, 1-octene, 1-decene, 1-dodecene, 1-tetra-decene and mixtures thereof; and
at least one liquid grinding aid, where the first processor has an impeller; and
grinding the components to produce an intermediate particulate non-porous poly(alpha-olefin) drag reducing agent of a first size;
feeding to a second processor the intermediate particulate non-porous poly(alpha-olefin) drag reducing agent of a first size, where the second processor has a stator having blades and the blades of the stator of the first processor have more gap between them than the blades of the stator of the second processor; and
grinding the components to produce the particulate non-porous poly(alpha-olefin) drag reducing agent dispersion in liquid where the particulate non-porous poly(alpha-olefin) drag reducing agent is of a second size smaller than the first size, and
where the grinding by both processors is conducted in the absence of cryogenic temperatures, where the liquid in the dispersion is the liquid grinding aid.

17. The method of claim 16 where particulate non-porous poly(alpha-olefin) drag reducing agent dispersion in liquid is not recycled to either processor.

18. The method of claim 16 where the granulated non-porous poly(alpha-olefin) has an average diameter of 0.5 inch (1.3 cm) or less, the first size of the intermediate particulate non-porous poly(alpha-olefin) drag reducing agent has an average particle size of from about 550 to about 450 microns, and the second size of the particulate non-porous poly(alpha-olefin) drag reducing agent is an average particle size ranging from about 175 to about 325 microns.

19. The method of claim 16 where the liquid grinding aid is a blend of at least one glycol selected from the group consisting of ethylene glycol, propylene glycol, diethylene glycol, dipropylene glycol, methyl ethers of such glycols, and mixtures thereof, and at least one other liquid selected from the group consisting of water and at least one alcohol, the alcohol being selected from the group consisting of methanol, ethanol, butanol, isopropanol, hexanol, heptanol, octanol and mixtures thereof.

20. The method of claim 16 where at least some of the intermediate particulate non-porous poly(alpha-olefin) drag reducing agent of a first size from the first processor is diverted rather than fed to the second processor, and at least part of the diverted intermediate particulate poly(alpha-olefin) drag reducing agent of a first size is combined with at least part of the particulate poly(alpha-olefin) drag reducing agent of a second size to give a bi-modal or multi-modal drag reducing agent product.

21. The method of claim 16 further comprising feeding a solid organic dispersion aid to the first processor.
